(19) United States
(12) Patent Application Publication
(10) Pub. No.: US 2022/0335530 A1
(43) Pub. Date: Oct. 20, 2022

(54) SYSTEM AND METHOD FOR VERIFIED IP ASSET PROFILES AND RANKINGS

(71) Applicant: Erich Lawson Spangenberg, Paris (FR)

(72) Inventor: Erich Lawson Spangenberg, Paris (FR)

(21) Appl. No.: 17/673,597

(22) Filed: Feb. 16, 2022

Related U.S. Application Data
(60) Provisional application No. 63/150,489, filed on Feb. 17, 2021.

(51) Int. Cl. G06Q 40/06; G06Q 50/18

(52) U.S. Cl. CPC G06Q 40/06; G06Q 50/184

(57) ABSTRACT

This invention pertains to a system and method for verified IP asset profiles and rankings for small or medium enterprises (SMEs), through the use of artificial intelligence (AI) and blockchain to create an intellectual property profile for SMEs that generates an algorithmic based score which is representation of the competitive strength of the SME's patent portfolio within its industry. This is based on the quality of patent assets, the commercialization and monetization potential of those assets and recent technology trends in global markets. Relevant data such as IP and financial data is collected from public and private sources on a global level. Essential attributes such as the competitive strength of that particular SME within its industry is also assessed.

### PRIORITY CLAIMS

This application claims the benefit of U.S. Provisional Application Ser. No. 63/150,489, filed Feb. 17, 2021, the contents of which are incorporated herein.

### BACKGROUND OF THE INVENTION

The field of invention is related to a system and method for verified IP asset profiles and rankings for small or medium enterprises (SMEs).

### SUMMARY OF THE INVENTION

Ninety-nine percent of all companies in the European Union are small or medium enterprises (SMEs). These SMEs provide two-thirds of private sector jobs and contribute more than half of the total added value created by all businesses in the EU. Despite many initiatives to try and increase the competitiveness of SMEs, enable better access to finance and increase commercial opportunities, EU SMEs are still failing to attract significant investment from the financial markets and missing out on commercial opportunities.

SMEs consistently highlight access to finance as one of the most pressing problems adversely affecting their business activity. Some progress has been made in improving the availability of financing and credit for SMEs through the provision of loans, guarantees and venture capital, but access to finance is still the greatest headache faced by individual SMEs. Enterprise-level companies searching for commercial partners have no way to quickly identify the most innovative SMEs within a particular industry based on a verified information.

One of the biggest roadblocks innovative SMEs face in gaining access to finance and commercial partners is the difficulty that commercial and financial partners have in identifying those exceptional and innovative SMEs.

Large enterprises face the flip side of that challenge: it's hard to identify the most innovative SMEs that would present excellent opportunities for strategic commercial partnerships that can benefit both firms.

IPwe Paradigm is revolutionizing this by making it easy to identify highly innovative SMEs for potential commercial and financial partners.

There are several well-known facts that researchers and the EU have identified about SMEs and intellectual property: May 2019 EU and EPO study: http://documents.epo.org/projects/babylon/eponet.nsf/0/FS9459A1E64B62F3C12583FC002FBD93/SFILE/highgrowth films study en.pdf and the rest of the world is in accord: https://www.researchgate.net/publication/270875011The importance of Intellectual Property for SMEs Challenges and Moving Forward;
SMEs are the backbone of the European economy
SMEs with intellectual property (IP) are significantly more likely to experience growth and even become high growth firms (HGFs)
Patent filings perform best as HGF predictors in both high-tech and low-tech industries and trademark filings perform best in consumer durable industries
SMEs that have bundles of IP (patents, trademarks and other IP assets) are even more likely to achieve high growth

Using game-changing technologies such as artificial intelligence (AI) and blockchain, IPwe has created an intellectual property profile for EU SMEs that is publicly accessible and free. Each profile highlights the IPwe Paradigm Score which is an algorithmic based representation and score of the competitive strength of the SME's patent portfolio within its industry. 368-180

IPwe uses a proprietary method of assessing the quality of the SME's verified patent assets held in the EU, along with other important factors such as the commercialization and monetization potential of those assets and recent technology trends in global markets.

IPwe Paradigm started out with a simple question: “How do we make it easier for potential commercial and financial partners to find the best EU SMEs to partner with?”

IPwe first assessed what private and public information is available on EU SMEs. We found that information to be scattered, inconsistent, difficult and in some cases expensive to access and find. In short, wholly inadequate!

IPwe then identified the essential attributes for any innovative and commercially viable SME, such as the competitive strength of that particular SME within its industry. Building on prior research from EU institutions, IPwe collected patent data, financial data and other relevant data from public and private sources on a global level. With respect to patents and trademarks, IPwe took the additional step of verifying EPO and other IP records to confirm the SME was in fact the record owner of the relevant IP assets. IPwe analysed this data using IPwe's proprietary method, including assessing the quality of the SMEs' verified patent assets that are currently held in the EU. IPwe also examined the commercialization and monetization potential of the activities of the SME and considered the impact of recent technology trends across global markets. Accessing public and private sources, we were able to obtain additional data that further supports the IPwe Paradigm Score.

These disparate data sources are analysed by IPwe' s proprietary AI algorithms to generate the IPwe Paradigm Score, an objective, repeatable and verifiable indicator of innovation held by all SMEs that hold IP in a particular industry and the relative rank of any individual SME within that ranking.

One of the unique features of IPwe Paradigm is that it doesn't rely only on companies to report their IP assets—it relies on independent verification of the assets. Key information (designated as “verified”) is verified by at least one external source IPwe deems reliable (such as the EPO for patent and trademark data). This means that the assets at the time indicated are properly recorded and reflected as being owned by the EU SME in the applicable IP office records, and in the case of patents, it is further confirmed by being listed on the Global Patent Registry (a Swiss Foundation). For other data, it will only be “verified” once a trusted third party confirms the accuracy of that data (e.g., number of employees or a historical performance metric). Unverified information may be included, but it is distinguished from verified data.

IPwe Paradigm will ensure innovative EU SMEs get noticed by commercial and potential financial partners. By laying out the competitive strength of a target SME within its industry, IPwe Paradigm makes it much easier to identify promising SMEs. SMEs who invest in IP deserve to be recognized and justly rewarded for their investment, commitment and achievements. IPwe Paradigm helps make that happen. With IPwe Paradigm now in context, we now present the “Business Case” for IPwe Paradigm and the core element of the IPwe Paradigm, the “IPwe Paradigm Report.”

### The IPwe Paradigm Business Case

IP is recognised as the currency of innovation, yet today that currency is all too often sitting unused, as if it were long-forgotten cash stuffed into a mattress. IP is the largest asset on many corporate balance sheets, but it frequently it is underappreciated, underutilized and undervalued.

IP may be the currency of innovation, but in today's world it's as if every company has its own currency, and no one knows the exchange rates. As a result, IP is improperly valued and broadly misunderstood. We know that billions of dollars are lost every year in missed IP transaction opportunities in just one major country,² and certainly innovative EU SMEs and commercial partners experience similar lost opportunities. IPwe Paradigm addresses this disconnect by providing a simple, more objective measure—much like other index scores such as bond or credit ratings. https://www.forbes.com/sites/danielfisher/2014/06/18/13633/?sh=2469833e6f1c

IPwe Paradigm is a free and publicly accessible source for EU SME IP information. The information is showcased in web-based reports and a searchable database of EU SMEs.

This tool gives the SME support community—finance, commercial partners, governments, universities and service providers—the ability to quickly access verified IP information about particular EU SMEs.

The key objectives of the IPwe Paradigm Report are to showcase for EU SMEs their verified IP, and supplemental information about their IP, intangible assets and products, services and markets in order to:
facilitate offers of capital, and other forms of potential financing and business with commercial partners, governments, universities and vendors,
open opportunities that the SMEs were unaware of in the EU and globally, and
ultimately accelerate their growth, and that of the broader EU and global innovation ecosystem.

The IPwe Paradigm Report offers information in plain language about verified IP assets. This information is freely available on demand and is updated real time on IPwe Paradigm.

The IPwe Paradigm Report consists of 4 sections:
1. Rating
2. IP Assets
3. Opportunities
4. Profiles

Rating. This section provides a comparison of the EU SME to its competitors in the relevant industry, based on its IPwe Paradigm Score. The IPwe Paradigm Score is an indication of the competitive strength of the SME within its industry based upon IPwe' s proprietary method of assessing the quality of its verified patent assets held in the EU and the additional factors described above.

The SME is then ranked based on its IPwe Paradigm Score on a leader board of 100 competitors, and the IPwe Paradigm Scores are shown for the industry average and the top five SMEs within that industry segment. Finally, this section provides a graphical quadrant chart for the SME and the top five SMEs in its industry based on their IPwe Paradigm Scores, highlighting attractive SMEs in the “magic quadrant” of innovative technology with strong commercial potential.

IP Assets: This Section provides an overview of the SMEs EU verified intellectual property (IP) assets by type in the EU and globally. Individual verified assets, including EU territory patents, trademarks, industrial design, copyrights and trade secrets are then presented. For patents, the presentation includes the number of patents, as well as a listing of the top 3 “crown jewel” patents based on IPwe' s proprietary method of assessing patent quality and validity.

The additional IP assets are then listed, including copyrights and trade secrets (which IPwe is actively recording and registering on the blockchain with relevant hashtags). This section also presents the combined IP assets of the SME in the top five geographies: EU, China, Japan, Korea and US, including indicating registrations by IPwe. Another feature of this section is the EU Patent designation for the SMEs' “crown jewel” inventors. The “EU Patent Degree” presents a designation of EPOx (with x as the number of patents that meet certain minimum criteria) for inventors of the top 1 to 3 crown jewel patents. IPwe also assigns an EPO Score for the quality of each inventor's patent portfolio of 1 to 3 stars.

Opportunities: This Section presents financing and commercial opportunities in order to facilitate potential financings and business with commercial partners, governments, universities and vendors. Given the importance attributed to ESG (environmental, social and governance) initiatives, IPwe is developing, in cooperation with a big four accounting firm, an ESG related index that gives prominence to those SMEs whose IP may have particular relevance to ESG initiatives.

Profile: This Section provides brief profile information for the EU SME, including basic founding and entity type, estimated revenues, and contact information. Added Benefits for EU SMEs.

To help all EU SMEs, IPwe Paradigm will provide EU SMEs free access to easy-to-use advanced AI analytics that they can use to improve their IP profiles. IPwe is seeking enterprise, government and professional service providers to join us in this mission to promote the commercial and financial success of the EU's most innovative SMEs for the benefit of us all.

In the near future, an EU SME may be able to offer additional important information about themselves to be included in IPwe Paradigm. An SME may choose, for example, to verify the number of employees or prior year's gross revenues by providing this information to IPwe along with a third party deemed reliable by IPwe that can verify this information. IPwe will accept this information from the SME (noting the source) and will only show the information as “verified” if a third party acceptable to IPwe confirms the accuracy of this information.

There is a “Paradigm Database” and a “website”. The collection of IPwe Paradigm reports can appear in alphabetical, country, industry, etc. order as selected by reader. One area to consider for this paper is the Paradigm Database that will complement the Report. “The information is showcased in web-based reports and a searchable database of EU SMEs.”

There is Verified IP Asset Reporting using CasperLabs blockchain and IBM's Hyperledger blockchain. It includes IP competitive strength, IP assets and IP help with financing opportunities.

You can use a general App, eg., when you put in a company name, you have the option of viewing their paradigm report (as another path to paradigm), the entry point being a company or maybe an industry (see the top 100 ranking of SMEs).

For the database, the fields from the report and a presentation of those fields allow the user to determine the entry point, such as they want to analyze based on geography regardless of industry, SME type (potential funding of micros but not medium), or export status. This is called terminal or dashboard.

Separate from the database, the other option is to receive reports, such as on “the most innovative SMEs”.

SMEs (eg, high profile EU SMEs based on business performance) that fall under the category of SMEs who have failed to secure any IP assets and don't have a paradigm report, but should have one, and should learn this fact and engage with IPwe to correct this. The database will be another path to identify them and invite them to add this missing tool to their success.

Long term, we collect these tools into the iPwe “Terminal” or “Dashboard”. (Maybe we just call it the IPwe Paradigm Dashboard). And that becomes the Research portal for IP (like any stock trading and analysis platform). UI where users have their widgets that they can customize. But we move away from “search” and closer to “answers”.

### BRIEF DESCRIPTION OF THE DRAWINGS

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIGS. 3A-C is an example of an IP asset report of the present invention.

FIGS. 4A-B is an example of an IP asset report of the present invention.

FIG. 5 is an example of an IP asset report of the present invention.

FIGS. 6A-C is an example of an IP asset report of the present invention.

FIGS. 7A-C is an example of an IP asset report of the present invention.

FIGS. 8A-C is an example of an IP asset report of the present invention.

### DETAILED DESCRIPTION OF THE PREFERRED EMBODIMENT

IPwe uses a proprietary method of assessing the quality of the SME's verified patent assets held in the EU, along with other important factors such as the commercialization and monetization potential of those assets and recent technology trends in global markets.

IPwe Paradigm started out with a simple question: “How do we make it easier for potential commercial and financial partners to find the best EU SMEs to partner with?”

IPwe first assessed what private and public information is available on EU SMEs. We found that information to be scattered, inconsistent, difficult and in some cases expensive to access and find. In short, wholly inadequate!

IPwe then identified the essential attributes for any innovative and commercially viable SME, such as the competitive strength of that particular SME within its industry. Building on prior research from EU institutions, IPwe collected patent data, financial data and other relevant data from public and private sources on a global level. With respect to patents and trademarks, IPwe took the additional step of verifying EPO and other IP records to confirm the SME was in fact the record owner of the relevant IP assets. IPwe analysed this data using IPwe's proprietary method, including assessing the quality of the SMEs' verified patent assets that are currently held in the EU. IPwe also examined the commercialization and monetization potential of the activities of the SME and considered the impact of recent technology trends across global markets. Accessing public and private sources, we were able to obtain additional data that further supports the IPwe Paradigm Score.

These disparate data sources are analysed by IPwe' s proprietary AI algorithms to generate the IPwe Paradigm Score, an objective, repeatable and verifiable indicator of innovation held by all SMEs that hold IP in a particular industry and the relative rank of any individual SME within that ranking.

One of the unique features of IPwe Paradigm is that it doesn't rely only on companies to report their IP assets—it relies on independent verification of the assets. Key information (designated as “verified”) is verified by at least one external source IPwe deems reliable (such as the EPO for patent and trademark data). This means that the assets at the time indicated are properly recorded and reflected as being owned by the EU SME in the applicable IP office records, and in the case of patents, it is further confirmed by being listed on the Global Patent Registry (a Swiss Foundation). For other data, it will only be “verified” once a trusted third party confirms the accuracy of that data (e.g., number of employees or a historical performance metric). Unverified information may be included, but it is distinguished from verified data.

IPwe Paradigm will ensure innovative EU SMEs get noticed by commercial and potential financial partners. By laying out the competitive strength of a target SME within its industry, IPwe Paradigm makes it much easier to identify promising SMEs. SMEs who invest in IP deserve to be recognized and justly rewarded for their investment, commitment and achievements. IPwe Paradigm helps make that happen.

With IPwe Paradigm now in context, we now present the “Business Case” for IPwe Paradigm and the core element of the IPwe Paradigm, the “IPwe Paradigm Report.”

### The IPwe Paradigm Business Case

IP is recognised as the currency of innovation, yet today that currency is all too often sitting unused, as if it were long-forgotten cash stuffed into a mattress. IP is the largest asset on many corporate balance sheets, but it frequently it is underappreciated, underutilized and undervalued.

IP may be the currency of innovation, but in today's world it's as if every company has its own currency, and no one knows the exchange rates. As a result, IP is improperly valued and broadly misunderstood. We know that billions of dollars are lost every year in missed IP transaction opportunities in just one major country,³ and certainly innovative EU SMEs and commercial partners experience similar lost opportunities. IPwe Paradigm addresses this disconnect by providing a simple, more objective measure—much like other index scores such as bond or credit ratings.

IPwe Paradigm is a free and publicly accessible source for EU SME IP information. The information is showcased in web-based reports and a searchable database of EU SMEs.

This tool gives the SME support community—finance, commercial partners, governments, universities and service providers—the ability to quickly access verified IP information about particular EU SMEs.

The key objectives of the IPwe Paradigm Report are to showcase for EU SMEs their verified IP, and supplemental information about their IP, intangible assets and products, services and markets in order to:
facilitate offers of capital, and other forms of potential financing and business with commercial partners, governments, universities and vendors,
open opportunities that the SMEs were unaware of in the EU and globally, and
ultimately accelerate their growth, and that of the broader EU and global innovation ecosystem.

The IPwe Paradigm Report offers information in plain language about verified IP assets. This information is freely available on demand and is updated real time on IPwe Paradigm.

The IPwe Paradigm Report consists of 4 sections:
5. Rating
6. IP Assets
7. Opportunities
8. Profiles

Rating. This section provides a comparison of the EU SME to its competitors in the relevant industry, based on its IPwe Paradigm Score. The IPwe Paradigm Score is an indication of the competitive strength of the SME within its industry based upon IPwe' s proprietary method of assessing the quality of its verified patent assets held in the EU and the additional factors described above.

The SME is then ranked based on its IPwe Paradigm Score on a leader board of 100 competitors, and the IPwe Paradigm Scores are shown for the industry average and the top five SMEs within that industry segment. Finally, this section provides a graphical quadrant chart for the SME and the top five SMEs in its industry based on their IPwe Paradigm Scores, highlighting attractive SMEs in the “magic quadrant” of innovative technology with strong commercial potential.

IP Assets: This Section provides an overview of the SMEs EU verified intellectual property (IP) assets by type in the EU and globally. Individual verified assets, including EU territory patents, trademarks, industrial design, copyrights and trade secrets are then presented. For patents, the presentation includes the number of patents, as well as a listing of the top 3 “crown jewel” patents based on IPwe's proprietary method of assessing patent quality and validity.

The additional IP assets are then listed, including copyrights and trade secrets (which IPwe is actively recording and registering on the blockchain with relevant hashtags). This section also presents the combined IP assets of the SME in the top five geographies: EU, China, Japan, Korea and US, including indicating registrations by IPwe. Another feature of this section is the EU Patent designation for the SMEs' “crown j ewel” inventors. The “EU Patent Degree” presents a designation of EPOx (with x as the number of patents that meet certain minimum criteria) for inventors of the top 1 to 3 crown jewel patents. IPwe also assigns an EPO Score for the quality of each inventor's patent portfolio of 1 to 3 stars.

Opportunities: This Section presents financing and commercial opportunities in order to facilitate potential financings and business with commercial partners, governments, universities and vendors. Given the importance attributed to ESG (environmental, social and governance) initiatives, IPwe is developing, in cooperation with a big four accounting firm, an ESG related index that gives prominence to those SMEs whose IP may have particular relevance to ESG initiatives.

Profile: This Section provides brief profile information for the EU SME, including basic founding and entity type, estimated revenues, and contact information.

To help all EU SMEs, IPwe Paradigm will provide EU SMEs free access to easy-to-use advanced AI analytics that they can use to improve their IP profiles. IPwe is seeking enterprise, government and professional service providers to join us in this mission to promote the commercial and financial success of the EU's most innovative SMEs for the benefit of us all.

In the near future, an EU SME may be able to offer additional important information about themselves to be included in IPwe Paradigm. An SME may choose, for example, to verify the number of employees or prior year's gross revenues by providing this information to IPwe along with a third party deemed reliable by IPwe that can verify this information. IPwe will accept this information from the SME (noting the source) and will only show the information as “verified” if a third party acceptable to IPwe confirms the accuracy of this information.

There is a “Paradigm Database” and a “website”. The collection of IPwe Paradigm reports can appear in alphabetical, country, industry, etc. order as selected by reader. One area to consider for this paper is the Paradigm Database that will complement the Report. “The information is showcased in web-based reports and a searchable database of EU SMEs.”

There is Verified IP Asset Reporting using CasperLabs blockchain and IBM's Hyperledger blockchain. It includes IP competitive strength, IP assets and IP help with financing opportunities.

You can use a general App, eg., when you put in a company name, you have the option of viewing their paradigm report (as another path to paradigm), the entry point being a company or maybe an industry (see the top 100 ranking of SMEs).

For the database, the fields from the report and a presentation of those fields allow the user to determine the entry point, such as they want to analyze based on geography regardless of industry, SME type (potential funding of micros but not medium), or export status. This is called terminal or dashboard.

Separate from the database, the other option is to receive reports, such as on “the most innovative SMEs”.

SMEs (eg, high profile EU SMEs based on business performance) that fall under the category of SMEs who have failed to secure any IP assets and don't have a paradigm report, but should have one, and should learn this fact and engage with IPwe to correct this. The database will be another path to identify them and invite them to add this missing tool to their success.

Long term, we collect these tools into the iPwe “Terminal” or “Dashboard”. (Maybe we just call it the IPwe Paradigm Dashboard). And that becomes the Research portal for IP (like any stock trading and analysis platform). UI where users have their widgets that they can customize. But we move away from “search” and closer to “answers”.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

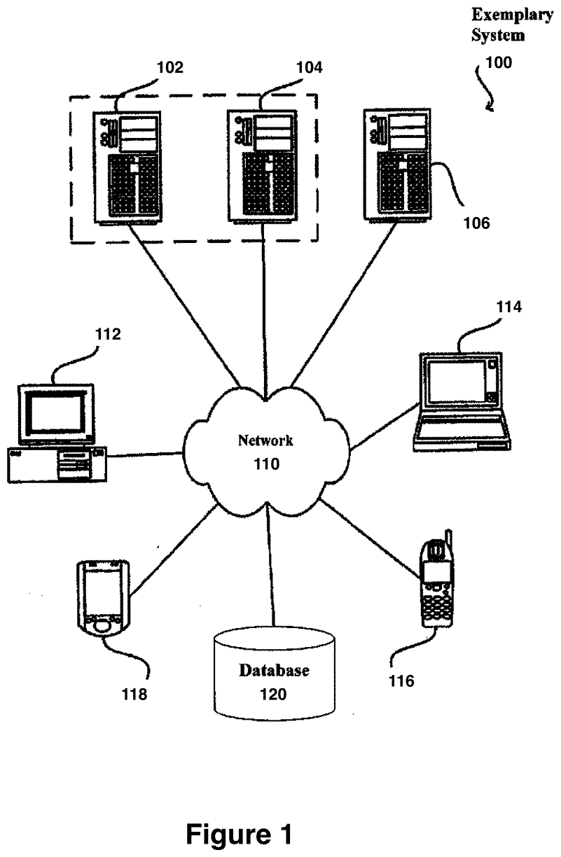

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet- enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle™, Microsoft™, Sybase™, IBM™ and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

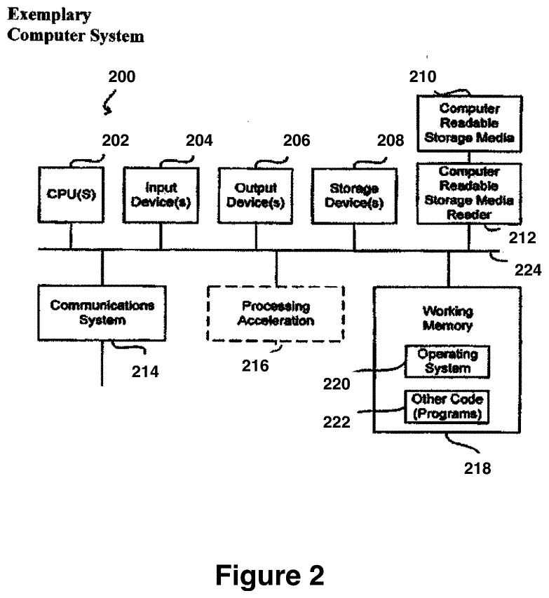

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid- state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on- demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium™. processor or the like. Similarly, a computer system (and additional instances of an enterprise database, where more than one is present) and all of their components might be operator configurable using application(s) including computer code run using a central processing unit such as an Intel Pentium™. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

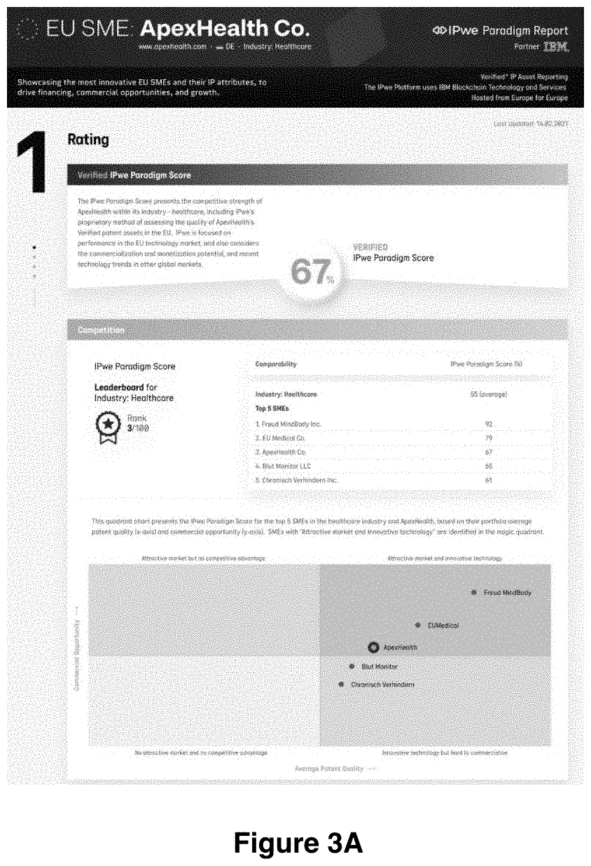

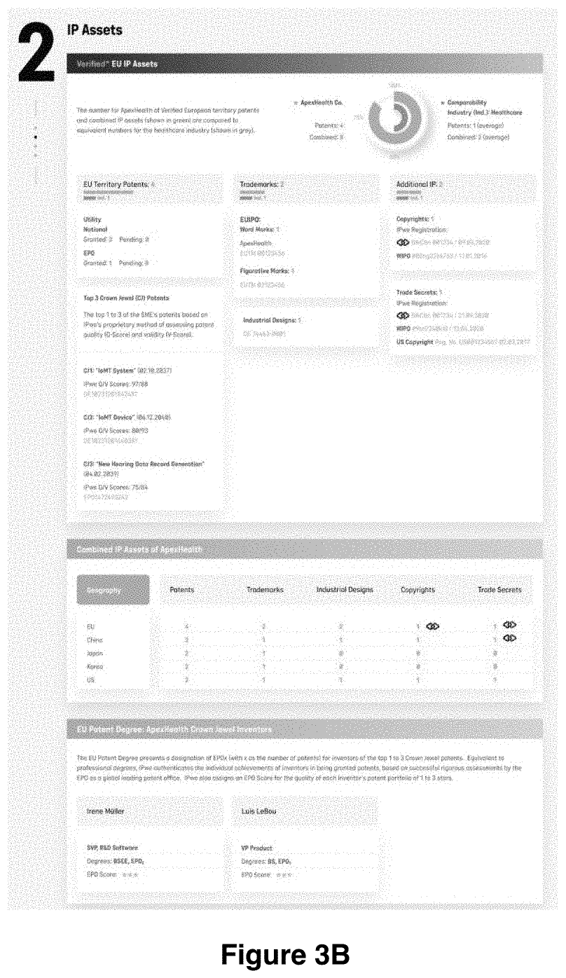

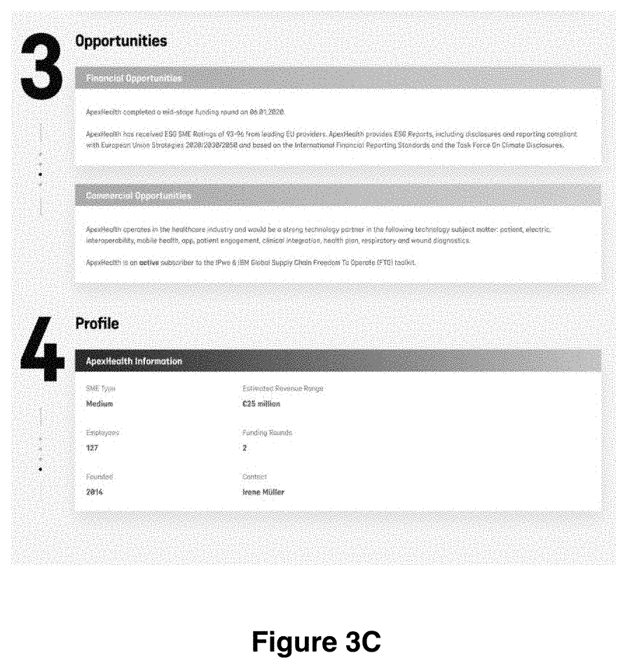

FIGS. 3A-C is an example of an IP asset report of the present invention. FIG. 3A shows the rating or verified paradigm score of the SME as well as a competitive analysis. FIG. 3B shows the verified IP assets. FIG. 3C shows a summary of financial and commercial opportunities as well as the overall SME.

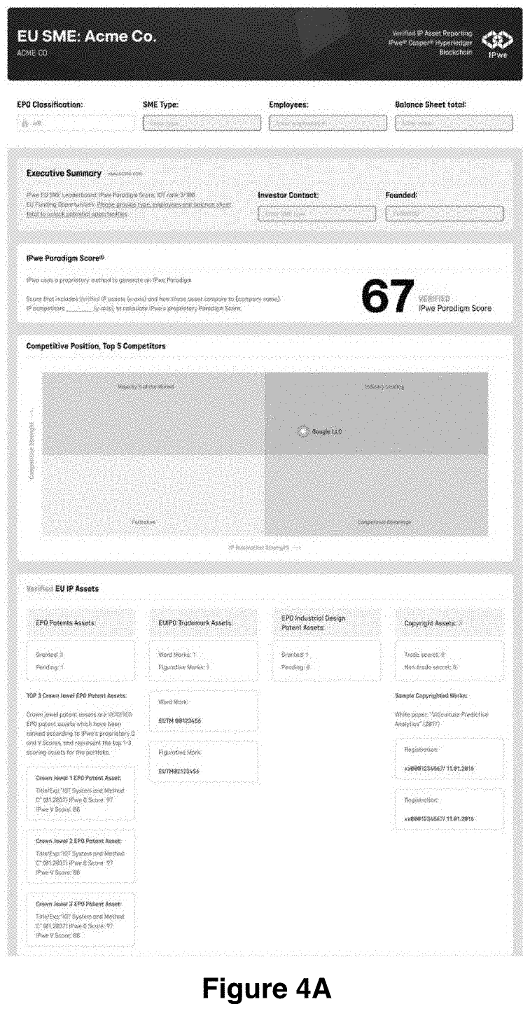

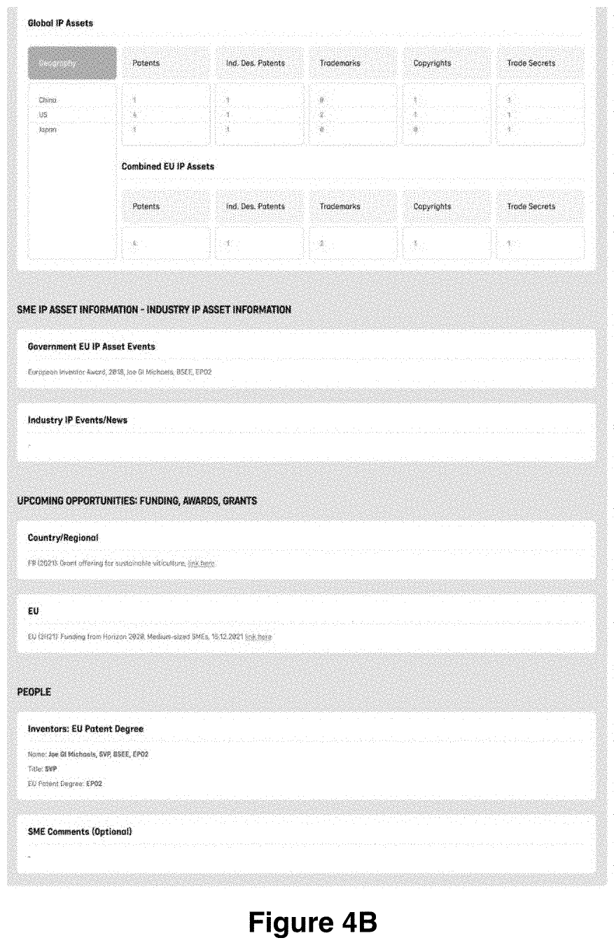

FIGS. 4A-B is an example of an IP asset report of the present invention. FIG. 4A shows information such as: EPO classification; SME type; employees; balance sheet total; executive summary; paradigm score; competitive position; and verified IP assets. FIG. 4B shows: global IP assets; industry IP asset information; upcoming opportunities; and people associated with the SME IP.

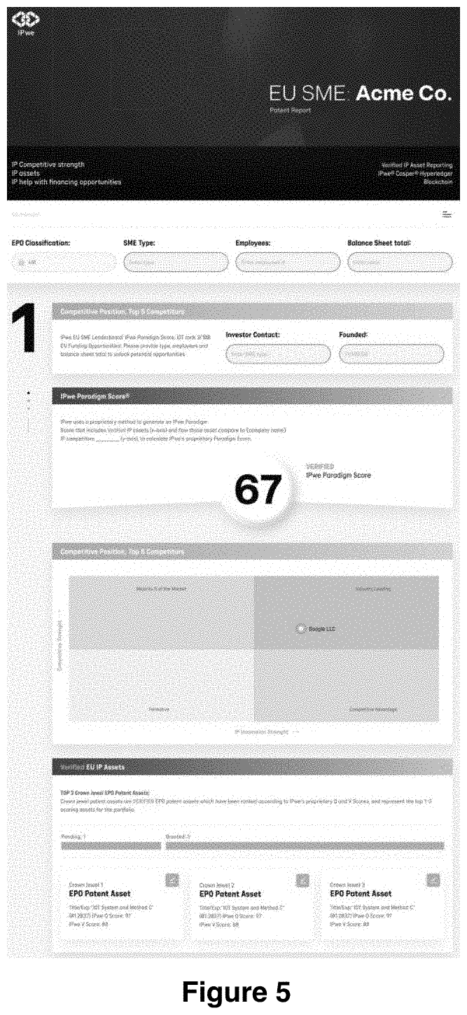

FIG. 5 is an example of an IP asset report of the present invention. This report shows the competitive position, paradigm score and verified IP assets of the SME.

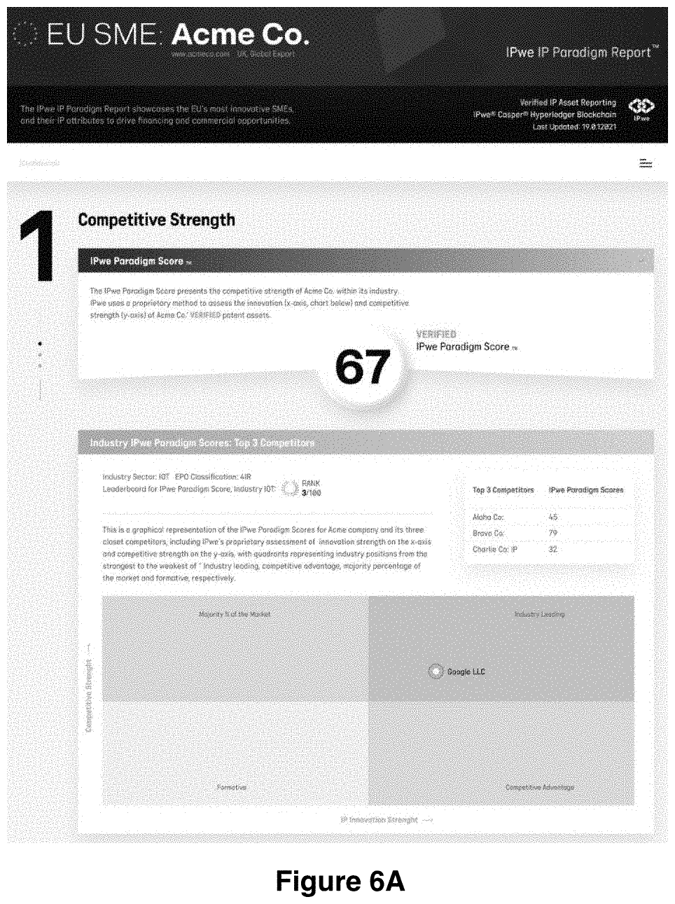

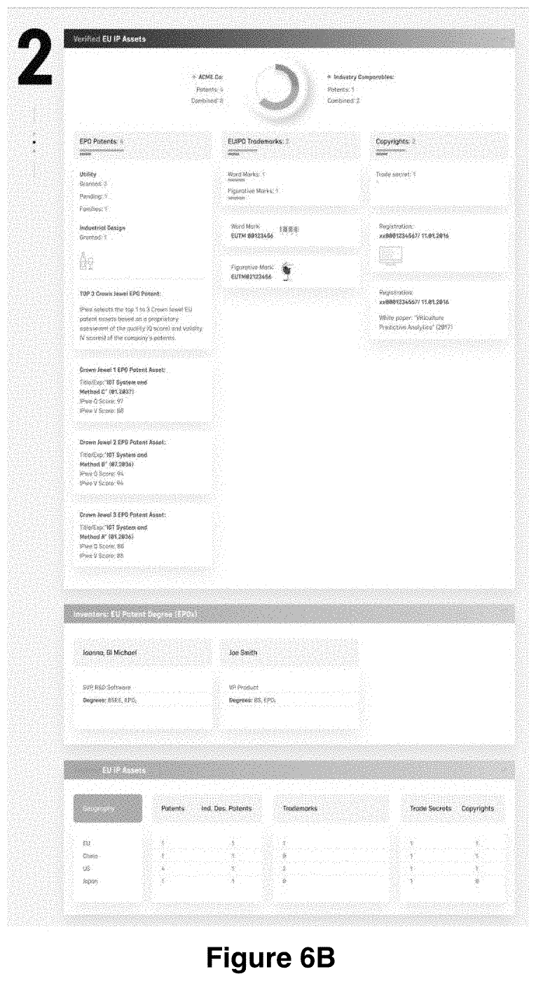

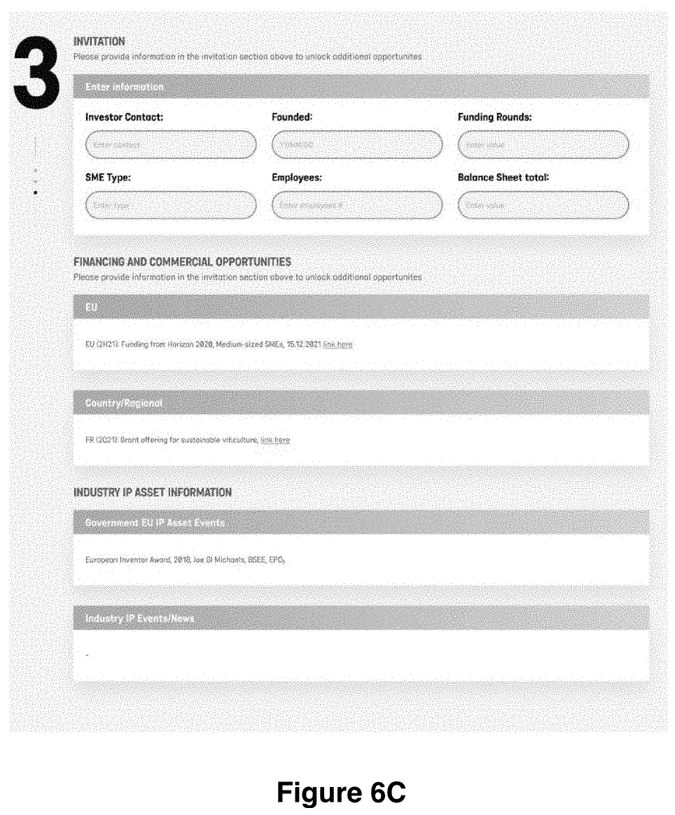

FIGS. 6A-C is an example of an IP asset report of the present invention. FIG. 6A shows competitive strength based on competitors paradigm scores. FIG. 6B shows verified IP assets, and inventors. FIG. 6C shows the invitations to various available investment opportunities.

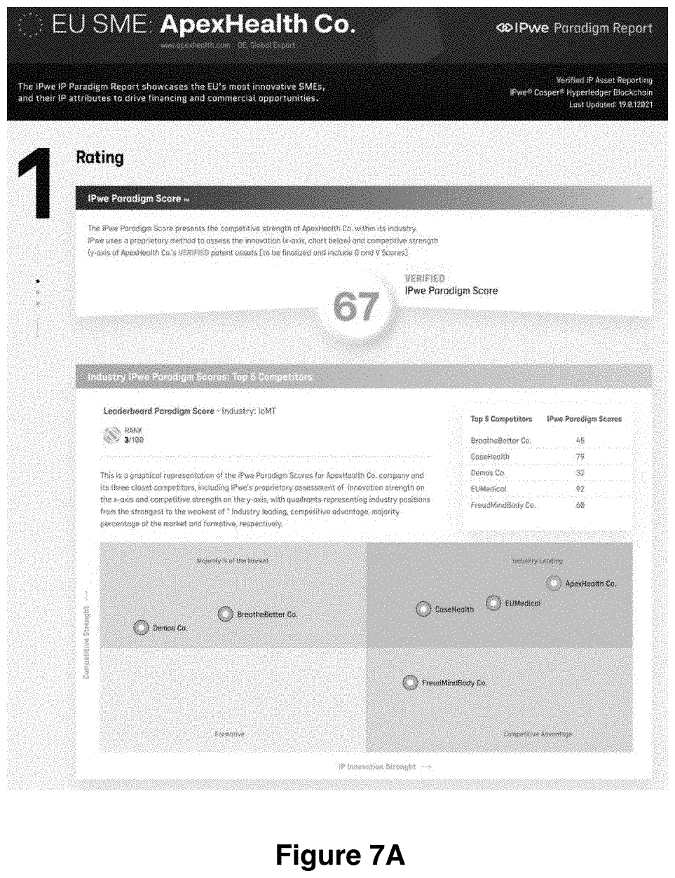

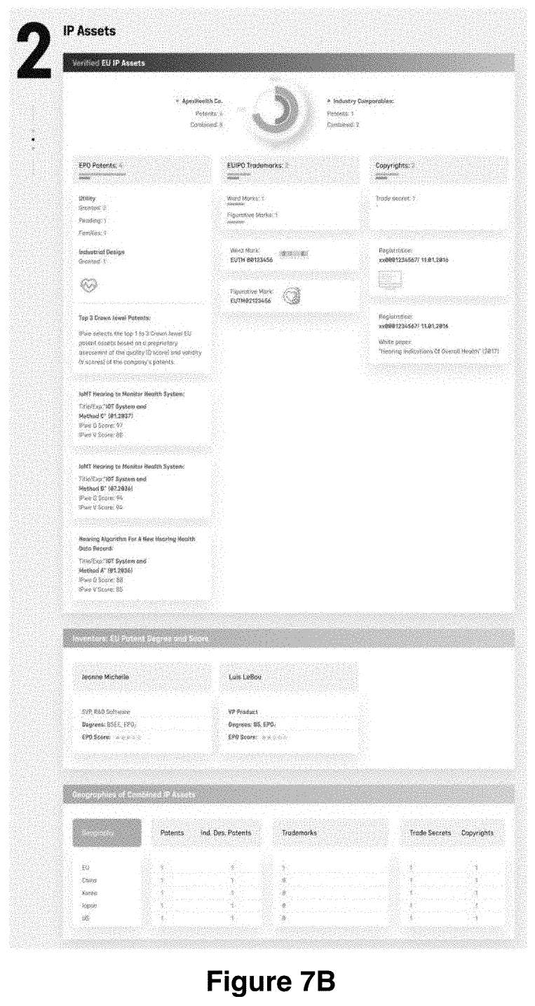

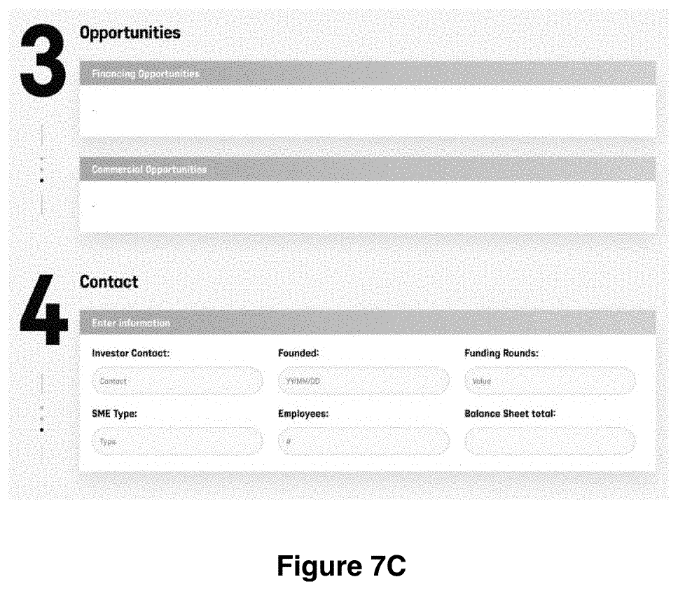

FIGS. 7A-C is an example of an IP asset report of the present invention. FIG. 7A shows an analysis of paradigm scores of the top 5 competitors. FIG. 7B shows information related to IP assets, inventors and countries. FIG. 7C shows available opportunities and contact information.

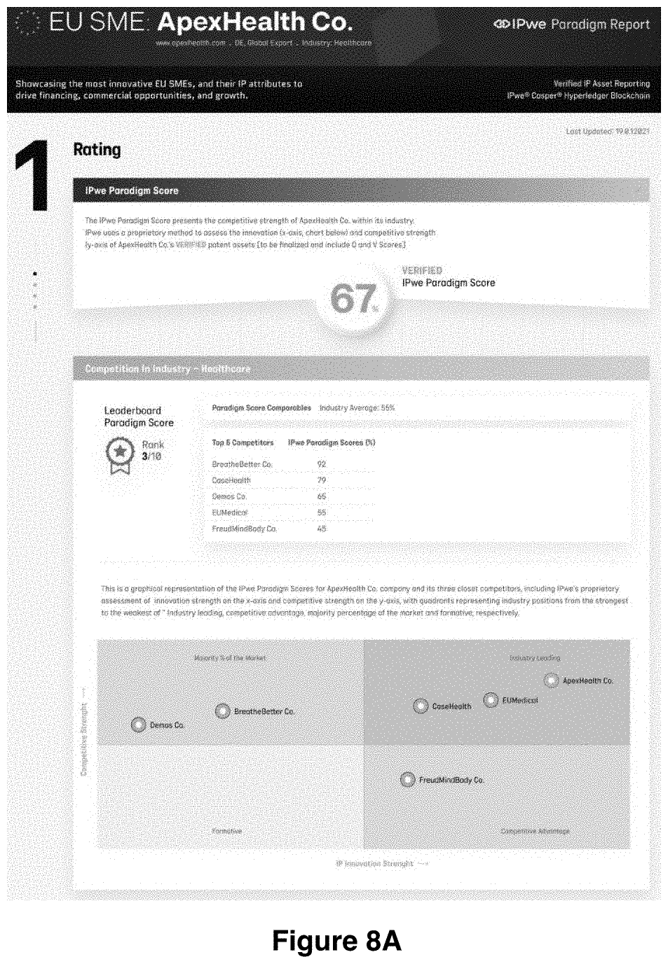

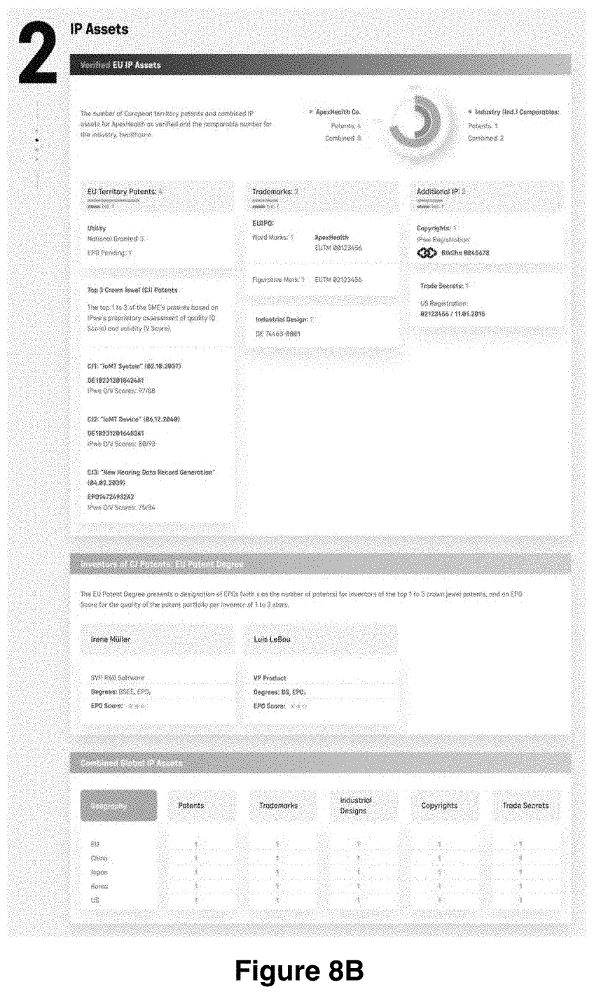

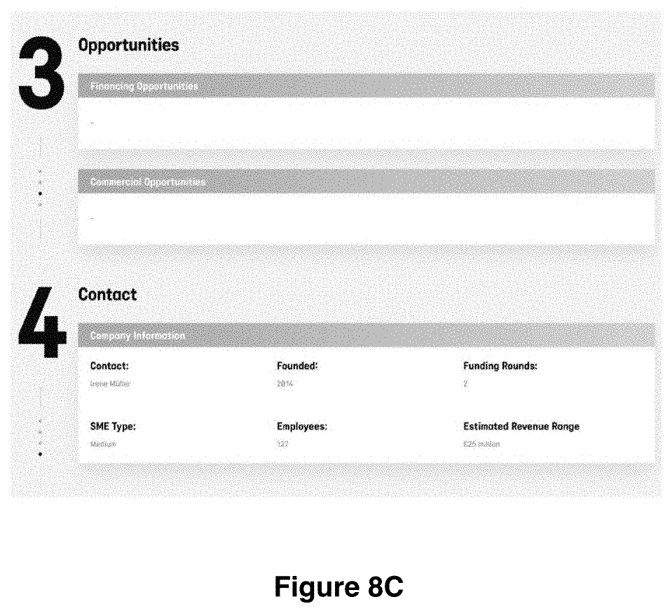

FIGS. 8A-C is an example of an IP asset report of the present invention. FIG. 8A shows a competitive analysis based on industry. FIG. 8B is a summary of IP assets, inventors and IP global location data. FIG. 8C shows available opportunities and contact information.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

1. (canceled)

2. A database management system for patent asset ownership verification and aggregation of said patent asset availability for inclusion within a patent asset pool, including:
a. a host database containing digital storage and network interfaces, under control of a host database control software and a host database CPU;
b. a telecommunications network connected to said host database for sending and receiving data files pertaining to said patent asset ownership verification and aggregation of said patent asset availability, wherein said telecommunications network provides said data files to said database and transmits said data files from said database under control of said host database control CPU as controlled by said host database control software;
c. one or more external data networks containing patent asset information accessible by way of said telecommunications network, so that said host database may be directed to access said one or more external data networks in response to a user inquiry;
d. an internet interface wherein said telecommunications network may access said one or more external data networks; and
e. a user interface in communication with said internet interface for directing inquiries to said host database, wherein said host database manages user inquiries by evaluation of existing said patent asset pools or said host database redirects said user inquiry to databases external to said host database in order to satisfy a patent pool asset query.

3. The system of claim 2 wherein said telecommunications network utilizes the TCP/IP protocol and redirects user inquiries from said host data base to said databases external to said host database.

4. The system of claim 2 wherein said user interface includes a browser for sending and receiving HTTP messages.

5. The system of claim 2 wherein an intellectual property asset report may be assembled by said host database by redirection to databases external to said host database through the use of said telecommunications network.

6. The system of claim 5 wherein small to medium enterprise users may obtain a patent pool opportunity report by way of said host database.

7. The system of claim 6 wherein said report includes contact information global assets, industry asset information, upcoming opportunities and a paradigm score.

8. The system of claim 2 implemented with network interfaces and peer to peer networks.

9. The system of claim 8 wherein said peer to peer networks are configured as a blockchain.

10. A method for distributing patent right acquisition opportunities by the use of an information database management system for patent asset ownership verification and aggregation of said patent asset availability for inclusion within a patent asset pool, including:
a. accessing a host database containing digital storage and network interfaces, under control of a host database control software and a host database CPU;
b. accessing a telecommunications network connected to said host database for sending and receiving data files pertaining to said patent asset ownership verification and aggregation of said patent asset availability, wherein said telecommunications network provides said data files to said database and transmits said data files from said database under control of said host database control CPU as controlled by said host database control software;
c. accessing one or more external data networks containing patent asset information accessible by way of said telecommunications network, so that said host database may be directed to access said one or more external data networks in response to a user inquiry;
d. accessing an internet interface wherein said telecommunications network may access said one or more external data networks; and
e. providing a user interface in communication with said internet interface for directing inquiries to said host database, wherein said host database manages user inquiries by evaluation of existing said patent asset pools or said host database redirects said user inquiry to databases external to said host database in order to satisfy a patent pool asset query.

11. The method of claim 10 wherein said telecommunications network utilizes the TCP/IP protocol and redirects user inquiries from said host data base to said databases external to said host database.

12. The method of claim 10 wherein said user interface includes a browser for sending and receiving HTTP messages.

13. The method of claim 10 wherein an intellectual property asset report may be assembled by said host database by redirection to databases external to said host database through the use of said telecommunications network.

14. The method of claim 13 wherein small to medium enterprise users may obtain a patent pool opportunity report by way of said host database.

15. The method of claim 14 wherein said report includes contact information global assets, industry asset information, upcoming opportunities and a paradigm score.

16. The method of claim 10 implemented with network interfaces and peer to peer networks.

17. The method of claim 16 wherein said peer to peer networks are configured as a blockchain.

18. A database management system for patent asset ownership verification and aggregation of said patent asset availability for inclusion within a patent asset pool, including:
a. a host database containing digital storage and network interfaces, under control of a host database control software and a host database CPU;
b. a telecommunications network connected to said host database for sending and receiving data files pertaining to said patent asset ownership verification and aggregation of said patent asset availability, wherein said telecommunications network provides said data files to said database and transmits said data files from said database under control of said host database control CPU as controlled by said host database control software;
c. one or more external data networks containing patent asset information accessible by way of said telecommunications network, so that said host database may be directed to access said one or more external data networks in response to a user inquiry;
d. an internet interface wherein said telecommunications network may access said one or more external data networks;
e. a user interface in communication with said internet interface for directing inquiries to said host database, wherein said host database manages user inquiries by evaluation of existing said patent asset pools or said host database redirects said user inquiry to databases external to said host database in order to satisfy a patent pool asset query, wherein said telecommunications network utilizes the TCP/IP protocol and redirects user inquiries from said host data base to said databases external to said host database and wherein said user interface includes a browser for sending and receiving HTTP messages.

19. The system of claim 18 wherein an intellectual property asset report may be assembled by said host database by redirection to databases external to said host database through the use of said telecommunications network.

20. The method of claim 18 implemented with network interfaces and peer to peer networks.

21. The method of claim 20 wherein said peer to peer networks are configured as a blockchain.
